(19) United States
(12) Patent Application Publication
(10) Pub. No.: US 2005/0276438 A1
(43) Pub. Date: Dec. 15, 2005

(54) Speaker device and method of manufacturing the speaker device

(76) Inventors: Hiroyuki Kobayashi, Yamagata (JP); Kenichi Kasahara, Yamagata (JP); Shinichi Hayasaka, Yamagata (JP); Toshihiro Hikichi, Yamagata (JP)

Correspondence Address: YOUNG & THOMPSON, 745 SOUTH 23RD STREET, 2ND FLOOR, ARLINGTON, VA, 22202, US

(21) Appl. No.: 11/086,322

(22) Filed: Mar. 23, 2005

(30) Foreign Application Priority Data
Mar. 25, 2004 (JP) 2004-89309

(51) Int. Cl. H04R 25/00

(52) U.S. Cl. 381/433; 381/182; 381/396

(57) ABSTRACT

A speaker device includes a magnetic circuit system having a resin frame and a plate. The frame holds the magnetic circuit system, and has a step portion, a hole portion, a recess portion and a slit. The step portion is formed on an inner surface of a peripheral edge portion of the frame, and the hole portion penetrates from a bottom surface of the step portion to the recess portion. The recess portion is formed on an outer surface of the frame. The slit is formed on the outer surface of the frame, and extends from the recess portion to the outer side. The step portion, the hole portion, the recess portion and the slit communicate with each other. Adhesive agent is applied to a gap between the outer peripheral edge portion of the plate and the inner peripheral wall of the frame.

### TECHNICAL FIELD

The present invention relates to a configuration of a frame in a speaker device.

### BACKGROUND ART

There is known an external magnet type speaker device in which a magnetic circuit system including a pole piece, an annular magnet disposed on a yoke of the pole piece and an annular plate disposed on the magnet is mounted onto a frame. In such the speaker device, each component of the magnetic circuit system is attached by an adhesive agent, and the magnetic circuit system is attached to an inner surface of the frame by the adhesive agent.

There is known a speaker unit in which a magnet, an upper plate and a lower plate are attached to each other by a photo-curing type adhesive agent (see Japanese Patent Application Laid-Open No. 2001-231094, for example). There is also known an internal magnet type magnetic circuit for a speaker which releases the air at the time of a rust prevention treatment and removes liquid such as paint and planting liquid by providing one or more through hole on a bottom portion of an inner peripheral joint surface of an outer yoke (see Japanese Patent Application Laid-Open No. 5-316594, for example).

However, when the above-mentioned speaker device is applied to a marine speaker device for example, by applying the adhesive agent to a gap between the plate and the frame, a sealed space is formed between the plate and the resin frame. Thus, while the adhesive agent is dried, bubbles occur by the volume change in the space and the bubbles are broken. Due to the broken bubbles, water drop and the like enter from the front side of the speaker device to reach the magnetic circuit system via the hole of the broken bubbles, which may corrode the magnetic circuit system.

In addition, in such the speaker device, since a damper is normally arranged in the vicinity of the upper portion of the plate, the bubbles are also attached to the damper. Therefore, at the time of reproduction, the damper is driven with a voice coil bobbin and a diaphragm, and the bubbles are vibrated, which may cause an abnormal sound.

### DISCLOSURE OF THE INVENTION

As a problem that the invention is to solve, the above problem is taken as an example. An object of the invention is to provide a speaker device capable of reinforcing an outer peripheral edge portion of a plate without corrosion of a magnetic circuit system and occurrence of an abnormal sound.

According to one aspect of the present invention, there is provided a speaker device which includes a magnetic circuit including a plate and a frame supporting the magnetic circuit, an outer peripheral portion of the plate being attached to an inner wall of the frame by an adhesive agent, wherein the frame includes a recess portion formed on an outer surface of a bottom portion of the frame, a slit formed from an outer edge of the recess portion to an outer side in a radial direction and a through hole communicating with an inner surface of the bottom portion and the recess portion.

The above speaker device includes the resin frame and the magnetic circuit system having the plate. The resin frame supports the magnetic circuit system, and has the through hole, the recess portion and the slit. The recess portion is formed on the outer surface of the bottom portion of the resin frame, and the slit is formed from the outer edge of the recess portion to the outer side in the radial direction. The through hole communicates with the inner surface of the bottom portion and the recess portion. Thereby, the through hole, the recess portion and the slit communicate with each other. In the process of reinforcing the outer peripheral edge portion of the plate, when the adhesive agent is applied to the gap between the outer peripheral edge portion of the plate and the inner peripheral wall of the resin frame to be dried, the volume change occurs to the space formed between the plate and the resin frame. However, the space communicates with the outer side of the speaker device through the step portion, the through hole, the recess portion and the slit. Thereby, the occurrence of the bubble due to the adhesive agent can be prevented. Therefore, the corrosion of the magnetic circuit system and the occurrence of the abnormal sound can be prevented, and the reinforcement of the outer peripheral edge portion of the plate can be stably performed.

In a form of the above speaker device, a step portion formed on the inner surface of the bottom portion of the frame may be included in an area having the through hole. In the process of reinforcing the outer peripheral edge portion of the plate, if the adhesive agent is applied to the gap between the outer peripheral edge portion of the plate and the inner peripheral wall of the resin frame, the adhesive agent is dropped to the bottom surface of the resin frame along the inner peripheral wall of the resin frame, which may clog the through hole. Therefore, by forming the step portion having an area larger than the through hole, it can be prevented that the adhesive agent clogs the through hole.

In another form of the above speaker device, the magnetic circuit may have a yoke, and the step portion may be formed up to an area of an outer side of the yoke. If the through hole is formed below the yoke of the speaker device, the path of the air is clogged, and the inner space cannot efficiently communicate with the outer side. Thus, the step portion is formed in the wide area including the through hole, and the path of the air is maintained. In a preferred example, central axes of the step portion and the through hole may coincide with each other.

In still another form of the above speaker device, the magnetic circuit may have a yoke, and the through hole may be formed in an area on an outer side of the yoke. If the through hole is formed below the yoke of the speaker device, the path of the air is clogged, and the inner space cannot efficiently communicate with outer side. Therefore, the through hole is formed on the outer side of the yoke, and the path of the air is maintained.

In a preferred example, the plural through holes may be formed in a circumferential direction of the speaker device. Additionally, in another preferred example, the plural slits may be formed in a circumferential direction of the speaker device. Thereby, the inner space can efficiently communicate with the outer side. The frame may be made of a resin material.

In still another form of the above speaker device, a name plate may be attached to the recess portion. After the adhesive agent applied between the outer peripheral edge portion of the plate and the inner peripheral wall of the resin frame is dried, the through hole becomes unnecessary. Therefore, the through hole is sealed with the name plate, and it is prevented that the moisture and the like form the outer side enter. In addition, attaching the name plate can make the speaker device look better.

According to another aspect of the present invention, there is provided a method of manufacturing a speaker device including: a process which disposes, on a workbench, a resin frame having a recess portion formed on an outer surface of a bottom portion, a slit formed from an outer edge of the recess portion to an outer side in a radial direction, and a through hole communicating with an inner surface of the bottom surface and the recess portion; a process which mounts, onto the resin frame, a magnetic circuit having a plate; a process which applies an adhesive agent between an outer peripheral portion of the plate and an inner wall of the resin frame; and a process which dries the adhesive agent in a state that inner and outer portions of the frame communicate with each other through the recess portion and the slit.

In the above method of manufacturing the speaker device, the resin frame is disposed on the workbench, and the magnetic circuit having the plate is mounted onto the resin frame. Subsequently, the adhesive agent is applied between the outer peripheral portion of the plate and the inner wall of the resin frame. Since the resin frame has the through hole, the recess portion and the slit, the adhesive agent is dried in the state that the inner side and the outer side of the frame communicate with each other through the recess portion and the slit. Thereby, the bubble due to the adhesive agent can be prevented. Therefore, the corrosion of the magnetic circuit system and the occurrence of the abnormal sound can be prevented, and the reinforcement of the outer peripheral edge portion of the plate can be stably performed.

In a form of the above method of manufacturing the speaker device, a name plate may be attached onto the recess portion after the adhesive agent is dried. After the adhesive agent applied between the outer peripheral edge portion of the plate and the inner peripheral wall of the frame is dried, the through hole becomes unnecessary. Therefore, the through hole is sealed with the nameplate, and it is prevented that the moisture enters from the outer side. In addition, attaching the name plate can make the speaker device look better.

### BRIEF DESCRIPTION OF THE DRAWINGS

FIG. 1A is a sectional view showing a configuration of a speaker device according to an embodiment of the present invention, and FIG. 1B is a rear view thereof;

FIG. 2 shows a sectional view in which a configuration of a resin frame according to this embodiment is enlarged;

FIG. 3 is a sectional view showing a process of applying an adhesive agent to a gap between an outer peripheral edge portion of a plate and an inner peripheral wall of the resin frame;

FIG. 4 is a sectional view showing a process of discharging air in a space compressed by the adhesive agent during drying;

FIG. 5 is a rear view showing the process of discharging the air in the space compressed by the adhesive agent during drying;

FIG. 6 is a rear view showing the configuration of the resin frame according to a modification; and

FIG. 7 is a sectional view showing the configuration of the resin frame according to the modification.

### BEST MODE FOR CARRYING OUT THE INVENTION

Hereinafter, preferred embodiment of the invention will be described by referring to the drawings. The speaker device of this embodiment has a configuration of the resin frame capable of preventing the bubble from occurring at the time of reinforcing the outer peripheral edge portion of the plate by the adhesive agent to form a sealed space. Thereby, the corrosion of the magnetic circuit system and the occurrence of the abnormal sound can be prevented.

[Configuration of Speaker Device]

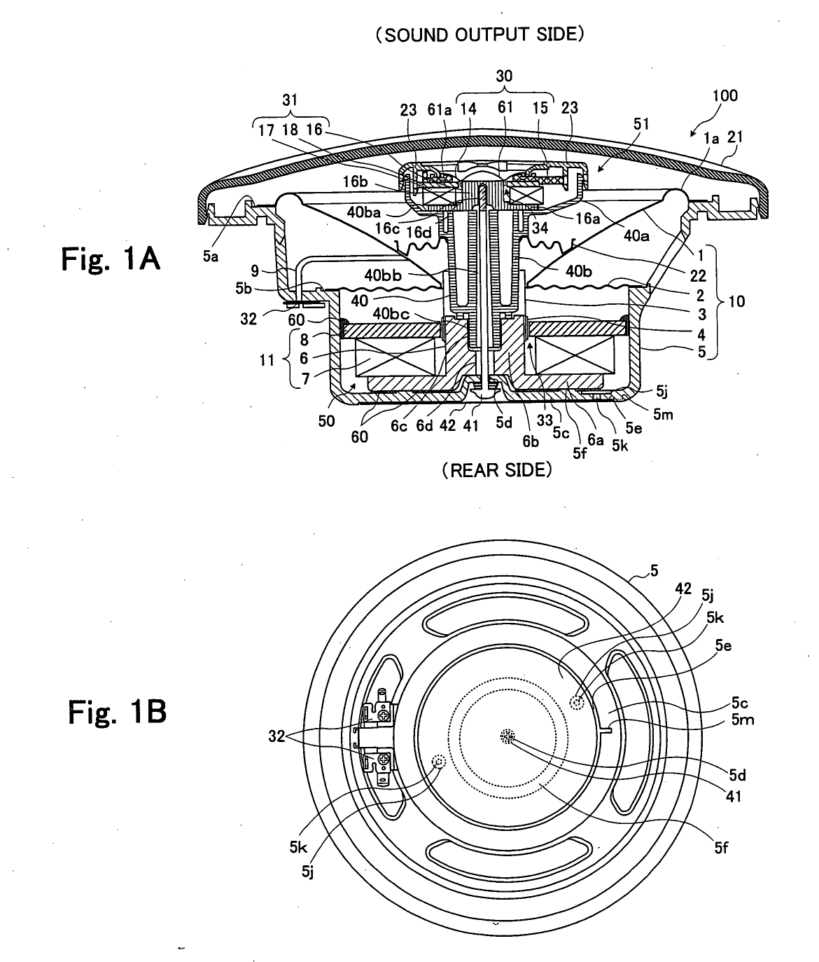

First, in FIGS. 1A and 1B, an outline configuration of a speaker device 100 according to the embodiment of the present invention is schematically shown. FIG. 1A is a sectional view when the speaker device 100 is cut along a plane containing a central axis thereof. FIG. 1B is a rear view of the speaker device 100. The speaker device 100 in the embodiment can be used preferably as a marine speaker. As below, referring to FIGS. 1A and 1B, the configuration etc. of the speaker device 100 of the embodiment will be described.

The speaker device 100 includes a speaker unit 50 for low-frequency band reproduction, a speaker unit 51 for high-frequency band reproduction, and other various kinds of members. The speaker device 100 is a so-called coaxial type two-way speaker, and is configured by coaxially disposing the speaker unit 51 for high-frequency band reproduction at the sound output side and the speaker unit 50 for low-frequency band reproduction at the rear side. Accordingly, the speaker device 100 can realize flat sound reproduction from the low-frequency band to the high-frequency band. Incidentally, the speaker unit 50 for low-frequency band reproduction may be a speaker unit capable of low and middle frequency band reproduction. Further, the speaker unit 51 for high-frequency band reproduction may be a speaker unit capable of high and middle frequency band reproduction.

First, a configuration of the speaker unit 50 for low-frequency band reproduction will be described. The speaker unit 50 for low-frequency band reproduction mainly includes a vibration system 10 having a diaphragm 1, a damper 2, a waterproof damper 22, a voice coil bobbin 3, a voice coil 4 and a resin frame 5, a magnetic circuit system 11 having a pole piece 6, an annular magnet 7 and an annular plate 8, and a resin grille 21.

First, the respective constitutive elements of the vibration system 10 will be described.

The diaphragm 1 is a so-called conical diaphragm, and a separate edge portion 1a is bonded thereto or the diaphragm 1 is formed integrally with the edge portion 1a. Various kinds of materials such as paper, polymer or metal can be applied to the diaphragm 1 according to various kinds of application. The outer peripheral edge of the diaphragm 1, namely, the lower end part of the edge portion 1a is fixed onto a first flange portion 5a located at the upper part of the resin frame 5. On the other hand, the inner peripheral edge of the diaphragm 1 is fixed onto the vicinity of the upper end of the outer circumferential wall of the voice coil bobbin 3.

The damper 2 is made of a material of cloth impregnated with a thermosetting resin such as phenol resin or the like, and plural corrugations are concentrically formed. The damper 2 movably supports the voice coil bobbin 3. The inner peripheral edge of the damper 2 is fixed to the outer circumferential wall of the voice coil bobbin 3. On the other hand, the outer peripheral edge of the damper 2 is fixed onto a second flange portion 5b formed in the vicinity of the central part of the resin frame 5.

The waterproof damper 22 fulfills a function of preventing water droplets etc. from entering from the sound output side into the magnetic circuit system 11 etc. For the purpose, as a material for the waterproof damper 22, for example, a material such as thermoplastic elastomer is appropriate. The outer peripheral edge of the waterproof damper 22 is mounted in a predetermined position of the diaphragm 1, and the inner peripheral edge of the waterproof damper 22 is mounted to the outer circumferential wall of a connecting portion 40b of a supporting member 40, which will be described later.

The voice coil bobbin 3 has a substantially cylindrical shape. The voice coil 4 is wound around the outer circumferential wall of the lower end part of the voice coil bobbin 3. Further, the outer circumferential wall of the lower end part of the voice coil bobbin 3 faces the inner circumferential wall of the annular plate 8 with a certain space therebetween. Furthermore, the inner circumferential wall of the lower end part of the voice coil bobbin 3 faces the outer circumferential wall of the upper end part of the pole piece 6 with a certain space therebetween. Thus, a gap (magnetic gap 33) is formed between the outer circumferential wall of the upper end part of the pole piece 6 and the inner circumferential wall of the plate 8.

The voice coil 4 has positive/negative lead terminals (not shown). The positive side lead terminal is an input terminal of L (or R) channel signal, and the negative side lead terminal is an input terminal of ground (GND: earth) signal. The respective lead terminals are electrically connected to the ends of respective tinsel wires 9 in the predetermined position of the diaphragm 1 and the other ends of the respective tinsel wires 9 are electrically connected to a connection terminal 32. To the voice coil 4, electric signals for one channel are input from an amplifier (not shown) side via the connection terminal 32 and the tinsel wires 9.

The resin frame 5 is a frame made of a resin material. Onto the resin frame 5, various components of the speaker device 100 are fixed, and the resin frame 5 serves to support the speaker device 100. The resin frame 5 has a shape of a pan or pot opening upwardly, and has the first flange portion 5a that supports the edge portion 1a of the diaphragm 1, the second flange portion 5b that supports the outer peripheral edge of the damper 2, and a mounting portion 5c on which the magnetic circuit system 11 is placed.

The first flange portion 5a is formed in a position of the upper part of the resin frame 5, and the second flange portion 5b is formed in a position of the central part of the resin frame 5. The mounting portion 5c is formed in a position at the lower part side of the resin frame 5, namely, at the rear side thereof. A recess having a truncated cone shape is formed in the vicinity of the central axis of the mounting portion 5c from the lower surface side to the upper surface side thereof. The mounting portion 5c has an opening 5d on the central axis thereof, a step portion 5j and a hole portion 5k in the vicinity of the peripheral edge thereof, and a recess (concave) portion 5e and a slit 5m at the rear side thereof. The step portion 5j, the hole portion 5k, the recess portion 5e and the slit 5m serve to prevent production of air bubbles of an adhesive agent 60 due to volume change of space between the magnetic circuit system 11 and the resin frame 5 at the time of assembly of the speaker unit 50 for low-frequency band reproduction. A fastening member 41, which will be described later, penetrates the opening 5d, and a nameplate 42, which will be described later, is attached to the recess portion 5e. The name plate 42 is used for application of improvement of the appearance of the rear side of the speaker 100 or recognition of product information etc. for users.

Next, the respective constitutive elements of the magnetic circuit system 11 will be described.

The magnetic circuit system 11 is formed as an external magnet type magnetic circuit. This magnetic circuit has the pole piece 6, the annular magnet 7 and the annular plate 8.

The pole piece 6 has an inverted T section. The pole piece 6 is fixed onto the mounting portion 5c of the resin frame 5 via the adhesive agent 60. The pole piece 6 has a flange-like yoke 6a, a center pole 6b having a cylindrical shape, and openings 6c and 6d provided within the center pole 6b.

The yoke 6a is located on the mounting portion 5c of the resin frame 5. A recess having a truncated cone shape is formed in the vicinity of the central axis of the lower surface side of the center pole 6b. The openings 6c and 6d formed within the center pole 6b are respectively different in diameter, and the openings communicate with each other. The opening 6c has a diameter slightly larger than that of the opening 6d, and is formed from the vicinity of the central part of the center pole 6b to the upper part thereof. On the other hand, the opening 6d is formed at the lower end side of the opening 6c, namely, from the central part side of the center pole 6b to the lower part thereof. Further, a lower end portion 40bc of the supporting member 40, which will be described later, is inserted into the opening 6c and the supporting member 40 is fastened to the center pole 6b. Furthermore, the fastening member 41 penetrates the openings 6c and 6d. Note that the fastening member 41 penetrates the opening 6c via a through hole 40bb of the supporting member 40, which will be described later.

The annular magnet 7 is disposed so as to be overlapped with the upper surface of the yoke 6a, and the annular plate 8 is disposed so as to be overlapped with the upper surface of the annular magnet 7. The center pole 6b upwardly extends within the openings of the central parts of the annular magnet 7 and the annular plate 8. The outer peripheral edge of the plate 8 is fixed for reinforcement to the inner circumferential wall of the resin frame 5 via the adhesive agent 60.

In the magnetic circuit system 11, a magnetic circuit is formed by the magnet 7, the plate 8 and the pole piece 6, and the magnetic flux of the magnet 7 is concentrated in the magnetic gap 33 formed between the inner circumferential wall of the plate 8 and the outer circumferential wall of the pole piece 6.

The resin grille 21 is made of a resin material, for example, and has a function of protecting the speaker unit 50 for low-frequency band reproduction and the speaker unit 51 for high-frequency band reproduction, or the like. For this purpose, the resin grille 21 is mounted on the resin frame 5 so as to cover the speaker units. Further, striped spacings (not shown) are formed intermittently at the upper surface side of the resin grille 21 so that the speaker unit 50 for low-frequency band reproduction and the speaker unit 51 for high-frequency band reproduction can emit sound waves through the spacings to the sound output side.

Next, the speaker unit 51 for high-frequency band reproduction will be described. The speaker unit 51 for high-frequency band reproduction mainly includes a vibration system 30 having a diaphragm 61, a voice coil 14 and an upper frame 15, and a magnetic circuit system 31 having a pole piece 16, an annular magnet 17 and an annular plate 18, and a cover 23.

First, the respective constitutive elements of the vibration system 30 will be described.

The diaphragm 61 is a so-called domical diaphragm, and is formed integrally with an edge portion 61a. Various kinds of materials such as paper, polymer, or metal can be applied to the diaphragm 61 according to various kinds of application as well as the above diaphragm 1. The outer peripheral edge of the diaphragm 61, namely, the lower end part of outer peripheral edge of the edge portion 61a is fixed onto the upper surface of the resin frame 15.

The voice coil 14 has a substantially cylindrical shape. The outer circumferential wall of the voice coil 14 faces the inner circumferential wall of the annular plate 18 with a certain space therebetween. On the other hand, the inner circumferential wall of the voice coil 14 faces the outer circumferential wall of the upper end part of the pole piece 16 with a certain space therebetween. Thus, a gap (magnetic gap 34) is formed between the outer circumferential wall of the pole piece 16 and the inner circumferential wall of the plate 18.

Further, the voice coil 14 has positive/negative lead terminals (not shown). The positive side lead terminal is an input terminal of L (or R) channel signal, and the negative side lead terminal is an input terminal of ground (GND: earth) signal. The respective lead terminals are electrically connected to the ends of respective tinsel wires (not shown) and the other ends of the respective tinsel wires (not shown) are electrically connected to a connection terminal (not shown) To the voice coil 14, electric signals for one channel are input from an amplifier (not shown) side via the connection terminal and the tinsel wires.

The upper frame 15 is made of a resin material and has a substantially annular form. The upper frame 15 is disposed so as to be overlapped with the upper surface of the annular plate 18. The upper frame 15 supports the outer peripheral edge of the diaphragm 61, namely, the edge 61a.

Next, the respective constitutive elements of the magnetic circuit system 31 will be described.

The magnetic circuit system 31 is formed as an external magnet type magnetic circuit system. The magnetic circuit has the pole piece 16, the annular magnet 17 and the annular plate 18.

The pole piece 16 has an inverted T section. Flatness is ensured in the lower surface of the pole piece 16. The pole piece 16 is fixed onto an upper end surface 40ba of the supporting member 40 via the adhesive agent 60 (not shown). The pole piece 16 has a flange-like yoke 16a, a center pole 16b having a cylindrical shape, a fastening hole 16c provided within the center pole 16b, and a step portion 16d formed between the outer peripheral edge of the lower end part of the center pole 16b and the yoke 16a and having a step-like section.

The yoke 16a is located on the upper end surface 40ba of the supporting member 40. A recess having a truncated cone shape is formed in the vicinity of the central axis of the lower surface side of the center pole 16b. The fastening hole 16c has a female thread, for example, and the leading end (for example, male thread) of the fastening member 41 is inserted and screwed. The outer circumferential wall of the step portion 16d is in contact with the outer circumferential wall of the lower end part of the magnet 17.

The annular magnet 17 is disposed so as to be overlapped with the upper surface of the yoke 16a. The inner circumferential wall of the lower end part of the annular magnet 17 is disposed at the outer circumferential side of the step portion 16d of the pole piece 16 as described above, and the annular magnet 17 is precisely positioned in a predetermined position on the yoke 16a. The annular plate 18 is disposed so as to be overlapped with the upper surface of the annular magnet 17.

In the magnetic circuit system 31, a magnetic circuit is formed by the magnet 17, the plate 18 and the pole piece 16, and the magnetic flux of the magnet 17 is concentrated in the magnetic gap 34 formed between the inner circumferential wall of the plate 18 and the outer circumferential wall of the pole piece 16.

The cover 23 is made of a resin material, for example, and mounted on a frame portion 40a of the supporting member 40, which will be described later, for covering the sound output side of the speaker unit 51 for high-frequency band reproduction. The cover 23 has a function of protecting the speaker unit 51 for high-frequency band reproduction, or the like.

As other various members of the speaker device 100, the supporting member 40, the fastening member 41 and the nameplate 42 are included.

The supporting member 40 has the connecting portion 40b having a cylindrical shape and the frame portion 40a extending from the upper end surface 40ba of the connecting portion 40b upwardly so as to cover the periphery of the speaker unit 51 for high-frequency band reproduction. The cover 23 is mounted on the frame portion 40a and covers the speaker unit 51 for high-frequency band reproduction. The connecting portion 40b coaxially arranges the speaker unit 50 for low-frequency band reproduction and the speaker unit 51 for high-frequency band reproduction. The lower end part 40bc of the connecting portion 40b is inserted into the opening 6c of the pole piece 6 and fastened as described above. The speaker unit 51 for high-frequency band reproduction is fixed to the upper end surface 40ba having flatness via the adhesive agent 60 (not shown). The through hole 40bb is formed within the connecting portion 40b so that it penetrates on the central axis thereof in a vertical direction, and the fastening member 41 penetrates the through hole 40bb.

As the fastening member 41, for example, a member such as a male screw or bolt is appropriate. At the leading end of the fastening member 41, a male thread corresponding to the female thread of the fastening hole 16c is formed. The fastening member 41 is inserted into the fastening hole 16c from the rear side of the speaker device 100 through the openings 5d, 6d and 6c and the through hole 40bb. Thereby, the speaker unit 50 for low-frequency band reproduction and the speaker unit 51 for high-frequency band reproduction are coaxially fixed via the supporting member 40.

The nameplate 42 is made of a polymer material or metal material and has a disc shape. The nameplate 42 is attached to the recess portion 5e of the resin frame 5 with a sticking agent or adhesive agent as described above. The product information, company name, etc. are printed on the nameplate 42.

In the above described speaker device 100, when electric signals are input to the respective tinsel wires from the amplifier side, the electric signals are supplied to the voice coils 4 and 14 via the respective lead terminals of the voice coils 4 and 14. Thereby, driving forces are generated in the voice coils 4 and 14 within the magnetic gaps 33 and 34, respectively, and the diaphragms 1 and 61 are vibrated in the axis direction of the speaker device 100. Thus, the speaker device 100 emits sound waves to the sound output side.

[Configuration of Resin Frame]

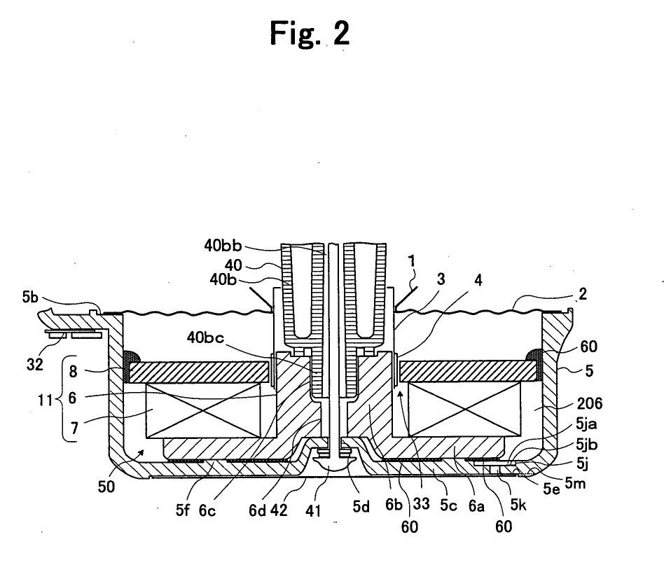

Next, the description will be given of the configuration of the resin frame 5 which is a characteristic of the present invention, with reference to FIGS. 1A and 1B and FIG. 2. FIG. 2 is a sectional view in which the vicinity of the magnetic circuit system 11 shown in FIG. 1A is enlarged.

On the mounting portion 5c of the resin frame 5, the step portions 5j, the hole portions 5k serving as through holes and the slit 5m are formed. The plural step portions 5j are formed in the vicinity of the peripheral edge of the mounting portion 5c, and each of them has a cylindrical space 5ja formed from the upper surface of the mounting portion 5c onto the inner side, and a bottom surface 5jb below the space 5ja. The space 5ja communicates with a space 206 formed by the magnetic circuit system 11 and the resin frame 5, which will be described later. One portion of the step portion 5j is positioned and formed on the outer side of the yoke 6a so that the step portion 5j is not sealed with the yoke 6a. In addition, the step portion 5j has a diameter larger than the hole portion 5k.

The hole portion 5k is a cylindrical through hole formed from the bottom surface 5jb of the step portion 5j to the recess portion 5e, and communicates with the space 5ja and the recess portion 5e. In addition, the diameter of the hole portion 5k is smaller than the diameter of the step portion 5j, and central axes thereof coincide with each other.

The slit 5m is a rectangular slit formed in the vicinity of the peripheral edge of the outer surface of the mounting portion 5c, and is formed in the outer direction from the outer edge of the recess portion 5e on the mounting portion 5c.

In the process of manufacturing the speaker device 100, the adhesive agent 60 is applied to a gap formed between the outer peripheral portion of the plate 8 and the inner peripheral wall of the resin frame 5, and both of them are attached. When the adhesive agent 60 is dried, the inner space is made to communicate with the speaker device 100 through the above-mentioned step portion 5j, hole portion 5k and slit 5m.

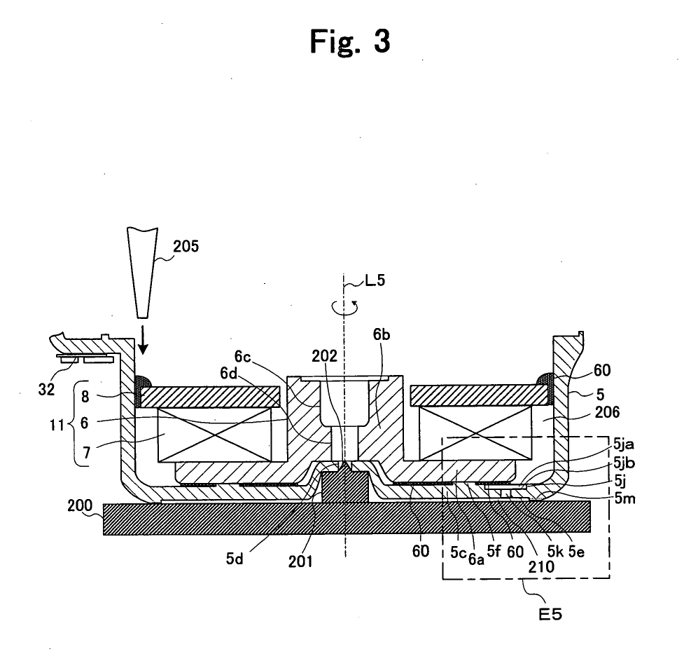

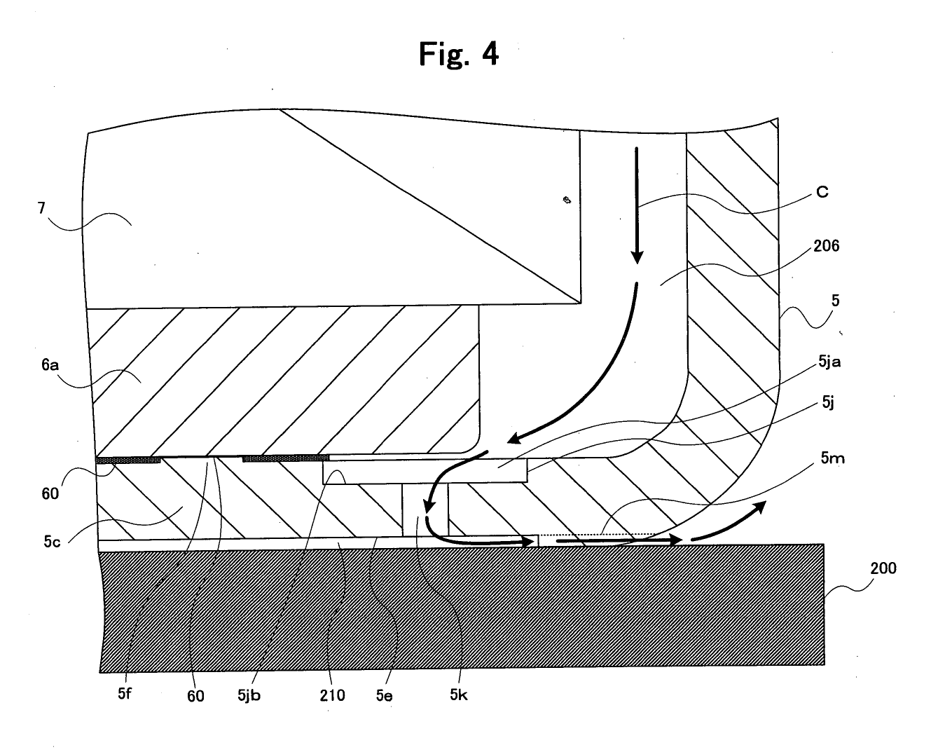

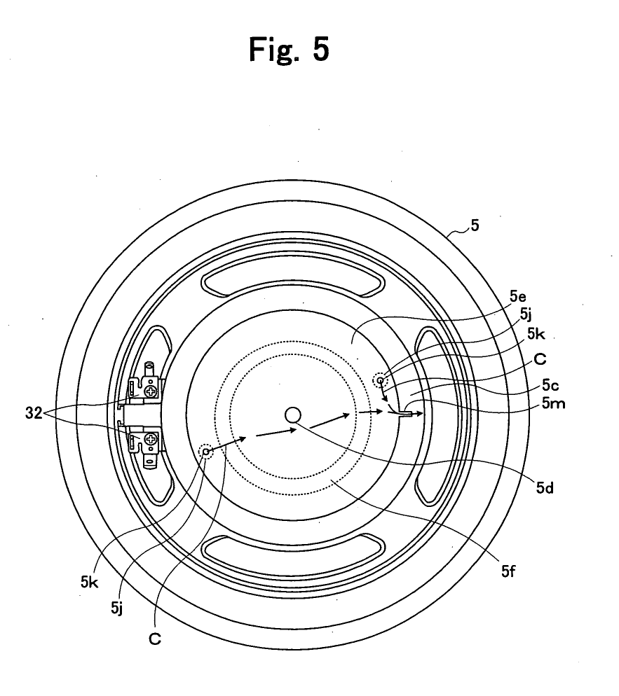

The description will be given of such an operation with reference to FIG. 3 to FIG. 5. FIG. 3 shows the process of attaching the magnetic circuit system 11 onto the mounting portion 5c via the adhesive agent 60 and afterward applying the adhesive agent 60 between the outer peripheral portion of the plate 8 and the inner peripheral wall of the resin frame 5. FIG. 4 shows a sectional view in which the vicinity of an area E5 (an area surrounded by the chain line) in FIG. 3 is enlarged, and FIG. 5 shows a rear view of the speaker device 100 corresponding to FIG. 3. Further, FIG. 4 and FIG. 5 show states that the air flows from the inner space when the adhesive agent 60 applied in the process of FIG. 3 is dried. It is noted that a workbench 200 shown in FIG. 4 is omitted in FIG. 5 for convenience of explanation.

As shown in FIG. 3, the resin frame 5 is disposed on the workbench 200, and the magnetic circuit system 11 is attached onto the mounting portion 5c on the inner side of the resin frame 5 via the adhesive agent 60. The workbench 200 is rotatable around a central axis L5 of the magnetic circuit system 11, and an upper surface thereof has flatness. On the workbench 200, a projecting portion 201 projecting upward from the vicinity of the central axis L5 on the upper surface is formed. On the projecting portion 201, a triangular-pyramidal pin 202 insertable into the opening 5d of the resin frame 5 is formed. The resin frame 5 is disposed on the workbench 200 so that the pin 202 of the projecting portion 201 is inserted into the opening 5d of the resin frame 5, and the workbench 200 is rotated around the central axis L5. Thereby, the resin frame 5 to which the magnetic circuit system 11 is attached can be rotated. In addition, as shown in FIG. 3, a nozzle 205 capable of discharging the adhesive agent 60 of a constant amount is disposed at a position above the outer peripheral portion of the plate 8.

By rotating the workbench 200 around the central axis L5 and discharging the adhesive agent 60 of the constant amount from the nozzle 205, the adhesive agent 60 is applied to the gap formed between the outer peripheral portion of the plate 8 and the inner peripheral wall of the frame 5. The reason why the adhesive agent 60 is applied to the gap between the outer peripheral portion of the plate 8 and the resin frame 5 is as follows. Namely, since such the speaker device 100 is preferably applicable as the marine speaker, the adhesion strength of the magnetic circuit system 11 and the resin frame 5 is enhanced, and the magnetic circuit system 11 is stably fixed to the resin frame 5.

In the above-mentioned process, when the amount of applied adhesive agent 60 is a little larger, the adhesive agent 60 sometimes flows to the area in the vicinity of the peripheral edge portion on the mounting portion 5c through the inner peripheral wall of the resin frame 5. However, on the resin frame 5, since the hole portion 5k is formed from the bottom surface 5jb of the step portion 5j to the recess portion 5e, the adhesive agent 60 never flows to the hole 5k, and the hole portion 5k is never clogged with the adhesive agent 60.

In addition, on the mounting portion 5c of the frame 5, an annular projecting portion 5f is formed. The adhesive agent 60 is applied between the upper surface of the projecting portion 5f and the bottom surface of the yoke 6a, and the yoke 6a is fixed to the frame 5. At this time, when the amount of applied adhesive agent 60 is a little larger, the adhesive agent 60 extruded from the adhesion surface flows into the inner and outer sides of the projecting portion 5f. The adhesive agent 60 extruded on the outer side accumulates on the inner side of the bottom surface 5jb (the bottom surface 5jb on the inner side of the hole portion 5k) by a step of the projecting portion 5f, particularly, by the step on the outer peripheral side. Thereby, it can be prevented that the hole portion 5k is clogged due to extrusion of the adhesive agent 60 for fixing the frame 5 and the yoke 6a.

In addition, by the adhesive agent 60 applied to the gap between the outer peripheral portion of the plate 8 and the inner peripheral wall of the frame 5, the air in the space 206 formed between the magnetic circuit system 11 and the resin frame 5 is compressed. As shown in FIG. 4 and FIG. 5, the air in the space 206 flows in the direction of an arrow C, and is ultimately discharged to the outer side of the speaker device 100. Concretely, as shown by the arrow C, the air exhausted into the space 206 is discharged to the outer side of the speaker device 100 through the space 5ja of the step portion 5j, the hole portion 5k, a space 210 formed between the recess portion 5e and the upper surface of the workbench 200, and the slit 5m in this order.

After the adhesive agent 60 is dried, since the hole portion 5k and the recess portion 5e become unnecessary, the name plate 42 is attached to the recess portion 5e of the mounting portion 5c as shown in FIGS. 1A and 1B to FIG. 2. In addition to making the speaker device 100 look better, this process effectively prevents external moisture and the like from entering the space 206 through the recess portion 5e and the hole 5k while the speaker device 100 is used.

In the above-mentioned embodiment, the semi-finished speaker device 100 is mounted on the workbench 200, and is left as it is for a constant time period. When the adhesive agent 60 is dried, the air compressed by the adhesive agent 60 is discharged to the outer side of the speaker device 100 through the hole portion 5k. However, the present invention is not limited to this. While the semi-finished speaker device 100 on an automatic conveyor is transmitted to the next process, the air compressed by the adhesive agent 60 may be discharged to the outer side of the speaker device 100.

As described above, according to the speaker device 100 having the above-mentioned resin frame 5, when the adhesive agent 60 is applied to the gap formed between the outer peripheral portion of the plate 8 and the inner peripheral wall of the frame 5 to attach them, the air in the space 206 compressed by the adhesive agent 60 can be effectively discharged to the outer side of the speaker device 100 by applying the adhesive agent 60 around the gap. The bubble never occurs in the space 206. Thereby, it can be prevented that the water enters from the front surface of the speaker device and the magnetic circuit system 11 corrodes. At the same time, occurrence of the abnormal sound can be prevented at the time of reproducing the sound, and the outer peripheral edge portion of the plate 8 can be stably reinforced. Since the above-mentioned step portion 5j, hole portion 5k, recess portion 5e and slit 5m are formed on the mounting portion 5c simultaneously with forming the resin frame 5, forming them does not increase the product cost of the resin frame 5.

[Modification]

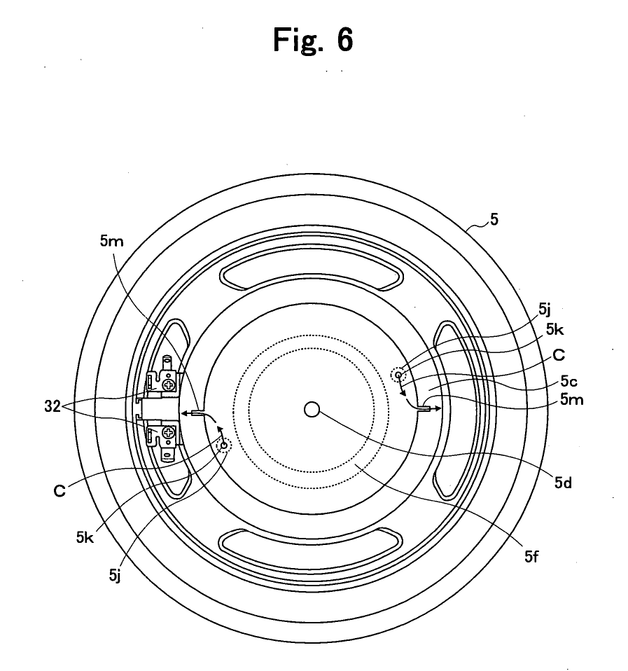

On the above-mentioned resin frame 5, one slit 5m is formed at the peripheral edge portion on the rear side of the mounting portion 5c. However, the plural slits 5m can be formed at the peripheral edge portion on the rear side of the mounting portion 5c. As shown in FIG. 6 which is the rear view of the resin frame 5 corresponding to FIG. 3, it is preferable that each slit 5m is formed in the vicinity of the hole portion 5k. Thereby, as shown in FIG. 6, when the outer peripheral edge portion of the plate 8 is reinforced, the compressed air in the space 206 can be efficiently discharged to the outer side of the speaker device 100. For convenience of the explanation, the workbench 200 is omitted in FIG. 6.

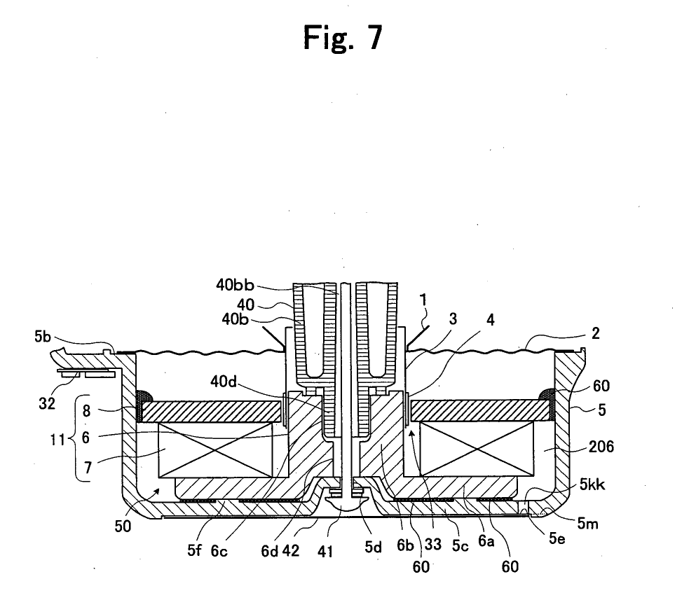

Additionally, on the above-mentioned resin frame 5, the step portion 5j is formed at the peripheral edge portion of the mounting portion 5c. However, the application of the present invention is not limited to this. Namely, on the resin frame 5, without forming the step portion 5j at the peripheral edge portion of the mounting portion 5c, the hole portion may be formed on the outer side of the yoke 6a. FIG. 7 shows a sectional view in a state that a hole portion 5kk is formed in the vicinity of the peripheral edge of the mounting portion 5c. As shown in FIG. 7, the hole portion 5kk penetrates between the upper surface of the mounting portion 5c and the recess portion 5e. Like this, if the hole portion 5kk is provided on the outer side of the yoke 6a, the hole portion 5kk is never sealed with the yoke 6a. Thereby, without forming the step portion 5j on the mounting portion 5c, the compressed air in the space 206 can be discharged to the outer portion of the speaker device 100 through the hole portion 5kk, the recess portion 5e and the slit 5m while the adhesive agent is dried.

In the above-mentioned embodiment, the present invention is applied to the coaxial speaker device 100, but the application of the present invention is not limited to this. Namely, the present invention is applicable to various kinds of speaker devices.

The speaker device of the present invention is preferably used not only as the marine speaker device but also as the vehicle speaker device. In the vehicle speaker device, the resin frame lighter than the metal frame is sometimes employed in terms of weight saving, and the magnetic circuit system is fixed onto the bottom surface of the resin frame having low rigidity by the adhesive agent. However, since various kinds of external forces such as a vibration from a road surface work on the vehicle speaker device, only attaching the magnetic circuit system onto the bottom surface of the resin frame is sometimes insufficient for the adhesion strength of the magnetic circuit system and the resin frame. Thus, by applying the adhesive agent to the gap between the outer peripheral edge portion of the plate and the inner peripheral wall of the opposite resin frame, the adhesion strength of the magnetic circuit system and the resin frame are enhanced. In such the case, the air compressed in the internal space by the adhesive agent can be efficiently discharged, and entering of a water drop and a moisture content can be prevented.

1. A speaker device comprising:
a magnetic circuit including a plate; and
a frame supporting the magnetic circuit, an outer peripheral portion of the plate being attached to an inner wall of the frame by an adhesive agent, wherein the frame includes a recess portion formed on an outer surface of a bottom portion of the frame, a slit formed from an outer edge of the recess portion to an outer side in a radial direction and a through hole communicating with an inner surface of the bottom portion and the recess portion.

2. The speaker device according to claim 1, wherein a step portion formed on the inner surface of the bottom portion of the frame is included in an area having the through hole.

3. The speaker device according to claim 2, wherein the magnetic circuit has a yoke, and the step portion is formed up to an area of an outer side of the yoke.

4. The speaker device according to claim 3, wherein central axes of the step portion and the through hole coincide with each other.

5. The speaker device according to claim 1, wherein the magnetic circuit has a yoke, and wherein the through hole is formed in an area on an outer side of the yoke.

6. The speaker device according to claim 1, wherein the plural through holes are formed in a circumferential direction of the speaker device.

7. The speaker device according to claim 1, wherein the plural slits are formed in a circumferential direction of the speaker device.

8. The speaker device according to claim 1, wherein the frame is made of a resin material.

9. The speaker device according to claim 1, wherein a name plate is attached to the recess portion.

10. A method of manufacturing a speaker device comprising:
a process which disposes, on a workbench, a resin frame having a recess portion formed on an outer surface of a bottom portion, a slit formed from an outer edge of the recess portion to an outer side in a radial direction, and a through hole communicating with an inner surface of the bottom surface and the recess portion;
a process which mounts, onto the resin frame, a magnetic circuit having a plate;
a process which applies an adhesive agent between an outer peripheral portion of the plate and an inner wall of the resin frame; and
a process which dries the adhesive agent in a state that inner and outer portions of the frame communicate with each other through the recess portion and the slit.

11. The method of manufacturing the speaker device according to claim 10, further comprising a process which attaches a name plate onto the recess portion after the adhesive agent is dried.
